(19) United States
(12) Patent Application Publication
(10) Pub. No.: US 2025/0224643 A1
(43) Pub. Date: Jul. 10, 2025

(54) DISPLAY STRUCTURE

(71) Applicant: PEGATRON CORPORATION, Taipei City (TW)

(72) Inventors: Pei-chun CHUNG, Taipei City (TW); Yi-chun WU, Taipei City (TW)

(21) Appl. No.: 18/928,488

(22) Filed: Oct. 28, 2024

(30) Foreign Application Priority Data
Jan. 4, 2024 (TW) 113200151

(51) Int. Cl. G02F 1/137; G02F 1/1335

(52) U.S. Cl. CPC G02F 1/13756; G02F 1/133504; G02F 1/133528

(57) ABSTRACT

The present disclosure provides a display structure. The display structure includes a display layer, a reflective polarizing layer, a dispersed liquid crystal layer and a pattern layer. The reflective polarizing layer is disposed at a side of the display layer. The dispersed liquid crystal layer is disposed at a side of the reflective polarizing layer away from the display layer. The pattern layer is disposed at a side of the dispersed liquid crystal layer away from the reflective polarizing layer. The combination of the reflective polarizing layer and the dispersed liquid crystal layer can prevent the pattern layer from affecting the overall display effect of the display layer when the display layer is turned on. The visual effect of the pattern layer can be also enhanced when the display layer is turned off.

### CROSS-REFERENCE TO RELATED APPLICATION

This application claims the priority benefit of Taiwan application serial no. 113200151, filed on Jan. 4, 2024. The entirety of the above-mentioned patent application is hereby incorporated by reference herein and made a part of this specification.

### TECHNICAL FIELD

The present disclosure relates to a display structure, and in particular, to a display structure with a decorative function.

### BACKGROUND

Generally, if displays require to serve decorative purposes, the typical approach is to attach a decoration plate (such as a wood decoration plate) to the display, so that the display and the car interior can appear integratedly.

When the decoration plate is attached to the display, a translucent scattering ink layer and a silver reflective layer are typically printed underneath the decoration plate. When the display is turned off, the silver ink of the silver reflective layer reflects external light to present the decoration pattern. When the display is turned on, the image shown by the display is visible through the translucent scattering ink layer. However, in this design, the scattering effect of the translucent scattering ink layer always exists whether the display is on or off. It is resulting in blurry and unclear images or text on the display to significantly affect the user's viewing experience.

### SUMMARY

One object of the present disclosure is to provide a display structure that can solve the problem in the prior art where the display function is affected by the scattering effect of the translucent scattering ink layer.

According to the aforementioned object, a display structure is provided. The display structure comprises a display layer, a reflective polarizing layer, a dispersed liquid crystal layer and a pattern layer. The reflective polarizing layer is disposed at a side of the display layer. The dispersed liquid crystal layer is disposed at a side of the reflective polarizing layer away from the display layer. The pattern layer is disposed at a side of the dispersed liquid crystal layer away from the reflective polarizing layer.

According to an embodiment of the present disclosure, the pattern layer comprises a screen-printing layer or an inkjet coating layer.

According to an embodiment of the present disclosure, the pattern layer comprises a plurality of pattern units arranged at intervals.

According to an embodiment of the present disclosure, each of the pattern units has an inclination angle relative to a boundary of the dispersed liquid crystal layer, and the inclination angle is between 0 degrees and 90 degrees.

According to an embodiment of the present disclosure, the transmittance of the pattern layer is between 50% and 100%.

According to an embodiment of the present disclosure, the display structure further comprises a complementary pattern layer disposed between the reflective polarizing layer and the display layer.

According to an embodiment of the present disclosure, a pattern of the complementary pattern layer corresponds to a pattern of the pattern layer, and a color of the complementary pattern layer is complementary to a color of the pattern layer.

According to an embodiment of the present disclosure, the reflective polarizing layer comprises a reflective brightness enhancement film, a metal grating polarizer or a cholesteric liquid crystal layer.

According to an embodiment of the present disclosure, the dispersed liquid crystal layer is configured to receive an external voltage, the dispersed liquid crystal layer is in a scattering state without receiving the external voltage, and the dispersed liquid crystal layer is in a transparent state when receiving the external voltage.

According to an embodiment of the present disclosure, the dispersed liquid crystal layer comprises liquid crystal molecules, when the dispersed liquid crystal layer is in the scattering state, the liquid crystal molecules in the dispersed liquid crystal layer are irregularly arranged.

As mentioned above, in the display structure provided by the present disclosure, the light utilization and transmittance of the display layer can be enhanced through the reflective polarizing layer combined with the dispersed liquid crystal layer when the display is turned on, thereby preventing the pattern layer from affecting the overall display quality of the display layer. Additionally, when the display layer is turned off, the external light can be reflected and the light uniformization is achieved by the reflective polarizing layer combined with the dispersed liquid crystal layer, thereby enhancing the visual effect of the pattern layer.

### BRIEF DESCRIPTION OF THE DRAWINGS

FIG. 1 is a schematic structural diagram of a display structure in a turned-off state according to an embodiment of the present disclosure.

FIG. 2 is a schematic structural diagram of a display structure in a turned-on state according to an embodiment of the present disclosure.

FIG. 3 a top view of a pattern layer disposed at a dispersed liquid crystal layer according to an embodiment of the present disclosure.

FIG. 4 is a side view of a pattern layer disposed at a dispersed liquid crystal layer according to an embodiment of the present disclosure.

FIG. 5 is a schematic structural diagram of a display structure in a turned-off state according to another embodiment of the present disclosure.

FIG. 6 is a schematic structural diagram of a display structure in a turned-on state according to another embodiment of the present disclosure.

### DETAILED DESCRIPTION

To facilitate understanding of the aforementioned objects, features, and advantages of the present disclosure, detailed descriptions of preferred embodiments are provided below, accompanied by the attached drawings. Additionally, directional terms such as up, down, top, bottom, front, back, left, right, inside, outside, side, around, central, horizontal, transverse, vertical, longitudinal, axial, radial direction, uppermost layer, or lowermost layer, etc., used in the present disclosure, are only based on the orientations depicted in the attached drawings. Therefore, these directional terms are only used to illustrate and express the present disclosure, but not to limit the present disclosure.

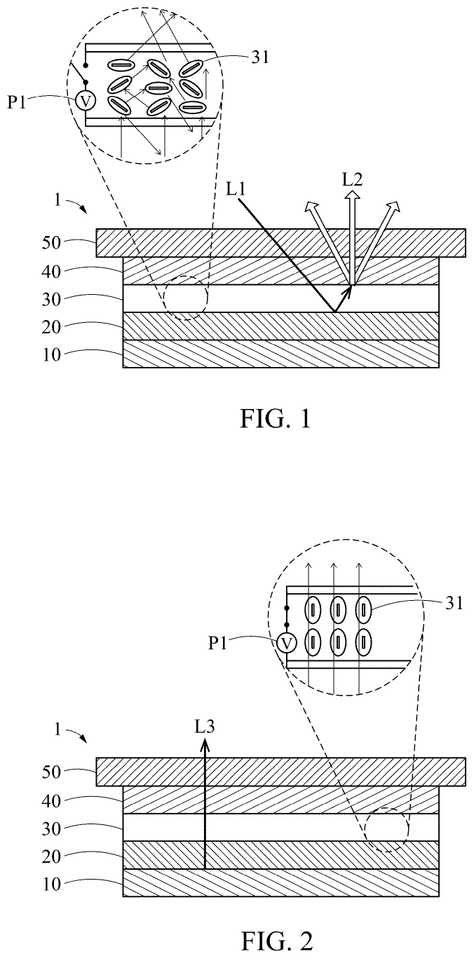

Referring to both FIG. 1 and FIG. 2, a display structure 1 of the present embodiment includes a display layer 10, a reflective polarizing layer 20, a dispersed liquid crystal layer 30, a pattern layer 40 and a cover plate 50 arranged in sequence. In other words, the reflective polarizing layer 20 and the dispersed liquid crystal layer 30 are positioned between the display layer 10 and the pattern layer 40 to provide reflection and scattering functions, respectively. Therefore, when the display layer 10 is turned off, the pattern of the pattern layer 40 can be clearly seen. Conversely, when the display layer 10 is turned on, the display layer 10 does not be affected by the pattern layer 40 and can achieve a good display effect. The cover plate 50 is disposed in front of the pattern layer 40 and is used to protect the components of each layer located behind the cover plate 50.

Specifically, the display layer 10 is used to provide display functions. The reflective polarizing layer 20 is disposed at a side of the display layer 10. In addition to increasing the light utilization rate of the display layer 10 when the display layer 10 is turned on, the reflective polarizing layer 20 may also reflect external light when the display layer 10 is turned off, thereby enhancing the visibility of the pattern layer 40. In one embodiment, the reflective polarizing layer 20 includes a dual brightness enhancement Film (DBEF), a metal grating polarizer or a cholesteric liquid crystal layer.

The dispersed liquid crystal layer 30 is disposed at a side of the reflective polarizing layer 20 away from the display layer 10. The dispersed liquid crystal layer 30 may be a polymer dispersed liquid crystal (PDLC) layer. The dispersed liquid crystal layer 30 includes liquid crystal molecules 31. The arrangement of the liquid crystal molecules 31 of the dispersed liquid crystal layer 30 may be controlled through voltage applying or not, thereby switching from a scattered state to a transparent state. The dispersed liquid crystal layer 30 is configured to receive an external voltage P1. Specifically, the dispersed liquid crystal layer 30 is connected to external voltage P1. As shown in FIG. 1, when the external voltage P1 is turned off, the dispersed liquid crystal layer 30 is unpowered, and the liquid crystal molecules 31 remain irregularly arranged. The irregularly arranged liquid crystal molecules 31 causes the dispersed liquid crystal layer 30 to appear hazy to cause the dispersed liquid crystal layer 30 to scatter light as light passes through. That is to say, the dispersed liquid crystal layer 30 is in the scattering state without receiving the external voltage P1. As shown in FIG. 2, when the external voltage P1 is turned on and applied to the dispersed liquid crystal layer 30, the liquid crystal molecules 31 are arranged neatly, enabling the dispersed liquid crystal layer 30 to appear transparent. That is to say, the dispersed liquid crystal layer 30 is in the transparent state when receiving the external voltage P1.

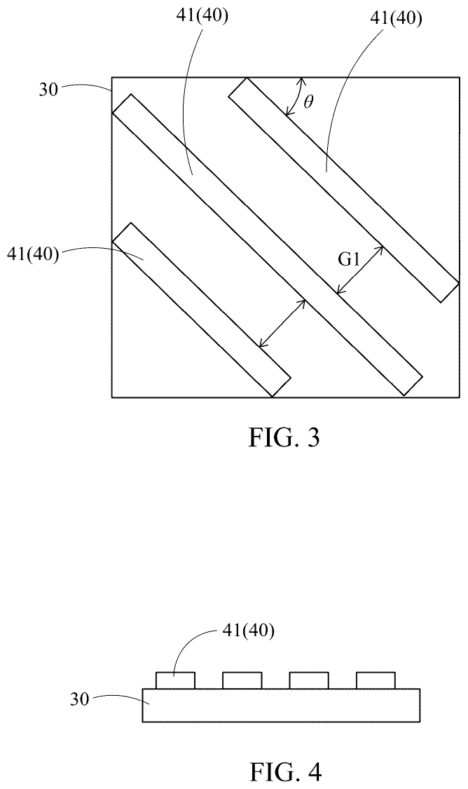

The pattern layer 40 is disposed at a side of the dispersed liquid crystal layer 30 away from the reflective polarizing layer 20. In one embodiment, the pattern layer 40 includes a screen-printing layer or an inkjet coating layer. In addition, the pattern layer 40 is a translucent layer and has a specific transmittance. In one embodiment, as shown in FIG. 3 and FIG. 4, the pattern layer 40 includes a plurality of pattern units 41 arranged at intervals. There is a gap G1 between any two adjacent pattern units 41. The gap G1 may be adjusted according to different optical requirements, so that the pattern units 41 may be arranged at equal or unequal intervals. In one embodiment, the transmittance of the overall pattern layer 40 is determined by the gap G1 between two adjacent pattern units 41, and the width or transparency of each pattern unit 41. In the present embodiment, the transmittance of the pattern layer 40 is between 50% and 100%. Each pattern unit 41 may be a slash pattern unit oriented at an inclination angle θ relative to the boundary of the dispersed liquid crystal layer 30. The inclination angle θ ranges between 0 degrees and 90 degrees, with 45 degrees being preferred but not limited to. The inclination angle θ may be designed according to the display requirements of the display layer 10 to prevent interference fringes (moire effect) between the pattern unit 41 and the display layer 10. In a specific example, the pattern layer 40 may be a wood grain pattern layer or other patterns.

Referring to FIG. 1 again, when the display layer 10 is turned off and no external voltage P1 is applied to the dispersed liquid crystal layer 30, the dispersed liquid crystal layer 30 is in the scattering state. The external light (such as light L1) can pass through the cover plate 50, the pattern layer 40 and the dispersed liquid crystal layer 30, and then be reflected by the reflective polarizing layer 20 to further emitted from the pattern layer 40. Thus, the pattern of the pattern layer 40 can be seen clearly. Additionally, the light reflected by the reflective polarizing layer 20 can be scattered by the dispersed liquid crystal layer 30. Thus, the light L2 scattered by the dispersed liquid crystal layer 30 pass through the pattern layer 40 and the cover plate 50. Because the light L2 is scattered, the anti-glare effect and the light uniformization can be achieved, and the visibility of the pattern layer 40 can be enhanced.

Referring to FIG. 2 again, when the display layer 10 is turned on and the dispersed liquid crystal layer 30 receives the external voltage P1, the dispersed liquid crystal layer 30 is in a transparent state. Light L3 emitted from the display layer 10 can pass through the reflective polarizing layer 20, dispersed liquid crystal layer 30, pattern layer 40, and cover plate 50, sequentially, so that the image shown on the display layer 10 can be seen clearly to enhance the visibility of the display layer 10.

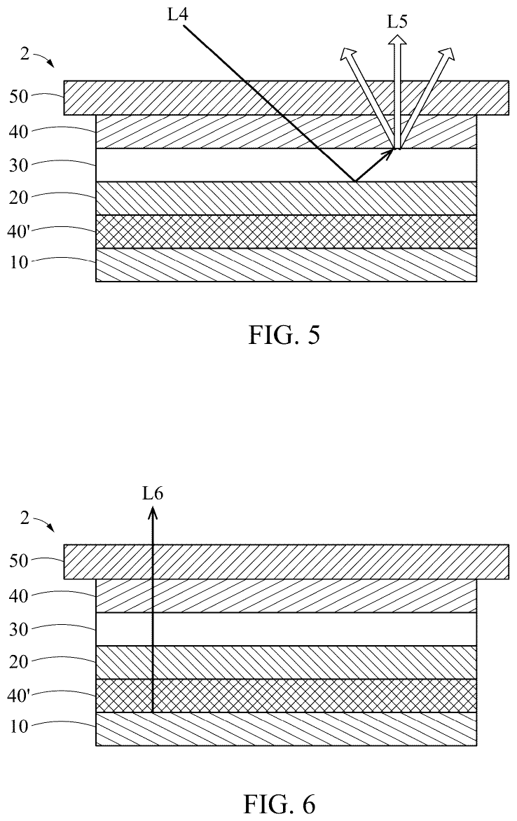

The display structure of the present disclosure can also have different structural designs. Referring to FIG. 5 and FIG. 6, which respectively depict schematic structural diagrams showing a display structure 2 in a turned-off state and a turned-on state according to another embodiment of the present disclosure. In the present embodiment, the display structure 2 is similar to the display structure 1 shown in FIG. 1 and FIG. 2, except that the display structure 2 in FIG. 5 and FIG. 6 includes a complementary pattern layer 40′. The complementary pattern layer 40′ is disposed between the reflective polarizing layer 20 and the display layer 10. In the present embodiment, the color of the complementary pattern layer 40′ is complementary to the color of the pattern layer 40. For example, the color of the complementary pattern layer 40′ and the color of the pattern layer 40 can form complementary pairs like red and green, or yellow and purple, but are not limited to single colors. The pattern layer 40 can consist of various color combinations or combinations within the same color system. The complementary pattern layer 40′ is formed by corresponding complementary color combinations or combinations within the same color system. In another embodiment, the complementary pattern layer 40′ is generated by digitally processing the pattern layer 40 using computer software. As a result, the complementary pattern layer 40′ can match the pattern layer 40 to create a grayscale effect. Additionally, the complementary pattern layer 40′ can also include a screen-printing layer or inkjet coating layer to provide a translucent pattern with specific transmittance.

As shown in FIG. 5, when the display layer 10 is turned off and the dispersed liquid crystal layer 30 does not receive the external voltage P1, the dispersed liquid crystal layer 30 is in the scattering state. Therefore, external light (such as light L4) can sequentially pass through the cover plate 50, the pattern layer 40 and the dispersed liquid crystal layer 30, and then be reflected by the reflective polarizing layer 20. Subsequently, the light reflected by the reflective polarizing layer 20 can be scattered by the dispersed liquid crystal layer 30, and then emit from the pattern layer 40 (such as light L5). At this time, the proportion of external light entering the display layer 10 and being reflected is small, so the influence of the complementary pattern layer 40′ can be ignored. Therefore, when the display layer 10 is in the turned-off state, only the pattern of the pattern layer 40 can be seen to achieve the original visual effect.

As shown in FIG. 6, when the display layer 10 is turned on and the dispersed liquid crystal layer 30 receives the external voltage P1, the dispersed liquid crystal layer 30 is in the transparent state. Light L6 emitted from the display layer 10 can sequentially pass through the complementary pattern layer 40′, the reflective polarizing layer 20, the dispersed liquid crystal layer 30, the pattern layer 40, and the cover plate 50. The pattern of the complementary pattern layer 40′ and the pattern of the pattern layer 40 can be matched to create a grayscale effect. This grayscale effect only affects the display brightness of the display layer 10 and does not impact the visual effect of the display layer 10.

According to the aforementioned embodiments of the present disclosure, in the display structure provided by the present disclosure, the light utilization and transmittance of the display layer can be enhanced through the reflective polarizing layer combined with the dispersed liquid crystal layer when the display layer is turned on, thereby preventing the pattern layer from affecting the overall display quality of the display layer. Additionally, when the display layer is turned off, the external light can be reflected and the light uniformization is achieved by the reflective polarizing layer combined with the dispersed liquid crystal layer, thereby enhancing the visual effect of the pattern layer.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present disclosure covers modifications and variations of this invention provided they fall within the scope of the following claims.

What is claimed is:

1. A display structure, comprising:
a display layer;
a reflective polarizing layer disposed at a side of the display layer;
a dispersed liquid crystal layer disposed at a side of the reflective polarizing layer away from the display layer; and
a pattern layer disposed at a side of the dispersed liquid crystal layer away from the reflective polarizing layer.

2. The display structure according to claim 1, wherein the pattern layer comprises a screen-printing layer or an inkjet coating layer.

3. The display structure according to claim 1, wherein the pattern layer comprises a plurality of pattern units arranged at intervals.

4. The display structure according to claim 3, wherein each of the pattern units has an inclination angle relative to a boundary of the dispersed liquid crystal layer, and the inclination angle is between 0 degrees and 90 degrees.

5. The display structure according to claim 1, wherein a transmittance of the pattern layer is between 50% and 100%.

6. The display structure according to claim 1, further comprising a complementary pattern layer disposed between the reflective polarizing layer and the display layer.

7. The display structure according to claim 6, wherein a pattern of the complementary pattern layer corresponds to a pattern of the pattern layer, and a color of the complementary pattern layer is complementary to a color of the pattern layer.

8. The display structure according to claim 1, wherein the reflective polarizing layer comprises a reflective brightness enhancement film, a metal grating polarizer or a cholesteric liquid crystal layer.

9. The display structure according to claim 1, wherein the dispersed liquid crystal layer is configured to receive an external voltage, the dispersed liquid crystal layer is in a scattering state without receiving the external voltage, and the dispersed liquid crystal layer is in a transparent state when receiving the external voltage.

10. The display structure according to claim 9, wherein the dispersed liquid crystal layer comprises liquid crystal molecules, when the dispersed liquid crystal layer is in the scattering state, the liquid crystal molecules in the dispersed liquid crystal layer are irregularly arranged.
